(19) United States
(12) Patent Application Publication
(10) Pub. No.: US 2012/0081923 A1
(43) Pub. Date: Apr. 5, 2012

(54) LIGHT EMITTING DIODE LAMP

(75) Inventors: Jheng-Syun Li, Hsin-Chu (TW); Ko-Wei Lee, Hsin-Chu (TW); Wen-Chiao Chang, Hsin-Chu (TW)

(73) Assignee: Young Lighting Technology Corporation, Hsin-Chu (TW)

(21) Appl. No.: 13/190,468

(22) Filed: Jul. 25, 2011

(30) Foreign Application Priority Data
Sep. 30, 2010 (TW) 99133377

(51) Int. Cl. F21V 7/22

(52) U.S. Cl. 362/612

(57) ABSTRACT

A light emitting diode lamp including a back plate, at least one cover, a light guide plate, at least one magnetic element, and a light emitting diode light source is provided. The cover is fixed to the back plate. The light guide plate is disposed on the back plate, and a part of the light guide plate is sandwiched between the back plate and the cover. The magnetic element is disposed on the back plate and sandwiched between the back plate and the cover. The light emitting diode light source is disposed at a side of the light guide plate.

### CROSS-REFERENCE TO RELATED APPLICATION

This application claims the priority benefit of Taiwan application serial no. 99133377, filed Sep. 30, 2010. The entirety of the above-mentioned patent application is hereby incorporated by reference herein and made a part of this specification.

### BACKGROUND OF THE INVENTION

1. Field of the Invention

The invention relates to a lamp and more particularly to a light emitting diode (LED) lamp.

2. Description of Related Art

Light emitting diodes (LEDs) are semiconductor devices. Light emitting chips are mainly fabricated using compounds of group III-V elements, for example, gallium phosphide (GaP) or gallium arsenide (GaAs). Moreover, LEDs emit light by converting electric energy into light energy. In details, LEDs apply currents to compound semiconductors so as to release excess energy in the form of light through the binding of electrons and holes. Since illumination of LEDs does not result from heating or discharging, the lifespan of LEDs could be longer than one hundred thousand hours. LEDs further include advantages such as fast responding speed, small volume, energy saving, low pollution, high reliability, suitable for mass production, and so on. Thus, LEDs could be widely applied in various fields, for instance, large display boards, traffic lights, cellular phones, scanners, light sources of fax machines, flat lamps and the like.

As for flat lamps, currently, the installation of a flat lamp requires screwing the base to a wall and then installing the flat lamp to the base, or screwing a lamp board directly on a wall. These installations consume more time and labor and it is unable to install when lack of installation components occur. In Taiwan Patent No. TWM386437, a lighting device adopting a magnet disposed thereon for adhering to a metal surface is disclosed. A side-lighting illumination device having a magnetic connector is disclosed in U.S. Pat. No. 7,766,502.

### SUMMARY OF THE INVENTION

The invention is directed to a light emitting diode lamp with simple installation.

The advantages of the invention are further illustrated from the technical characteristics disclosed in the invention.

One of the embodiments of the invention provides an LED lamp to achieve one or a part of or all of the objectives above-mentioned or other objectives. The LED lamp includes a back plate, at least one cover, a light guide plate, at least one magnetic element, and an LED light source. The cover is fixed to the back plate. The light guide plate is disposed on the back plate and a part of the light guide plate is sandwiched between the back plate and the at least one cover. The at least one magnetic element is disposed on the back plate and sandwiched between the back plate and the at least one cover. The light emitting diode light source is disposed at a side of the light guide plate.

In light of the foregoing, the embodiment aforementioned has at least one following advantage. The LED lamp is fixed to the surface through the magnetic element without screwing so that the installation and un-installation of the lamp become more convenient. In addition, the cover configured to fix the magnetic element also functions to fix the light guide board, such that the entire structure is more stable and the assembly of the components could be simplified.

Other objectives, features and advantages of the invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a three-dimensional (3D) diagram illustrating a light emitting diode (LED) lamp according to an embodiment of the invention.

FIG. 2 shows an explosion diagram of the LED lamp in FIG. 1.

FIG. 3 shows a partial explosion diagram of the LED lamp in FIG. 1.

FIG. 4 illustrates a schematic diagram of fixing the LED lamp in FIG. 1 on a surface.

FIG. 5 is a 3D diagram of the LED lamp in FIG. 1 from another viewing angle.

FIG. 6 depicts a side view of a magnetic element in FIG. 2.

FIG. 7 is a 3D diagram showing a cover in FIG. 1.

FIG. 8 is a 3D diagram illustrating an LED lamp according to another embodiment of the invention.

FIG. 9 is a 3D diagram of the LED lamp in FIG. 8 from another viewing angle.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

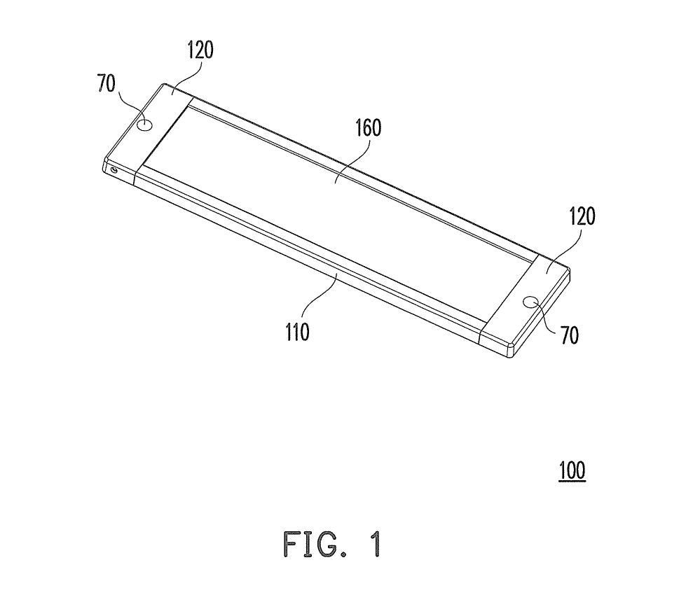

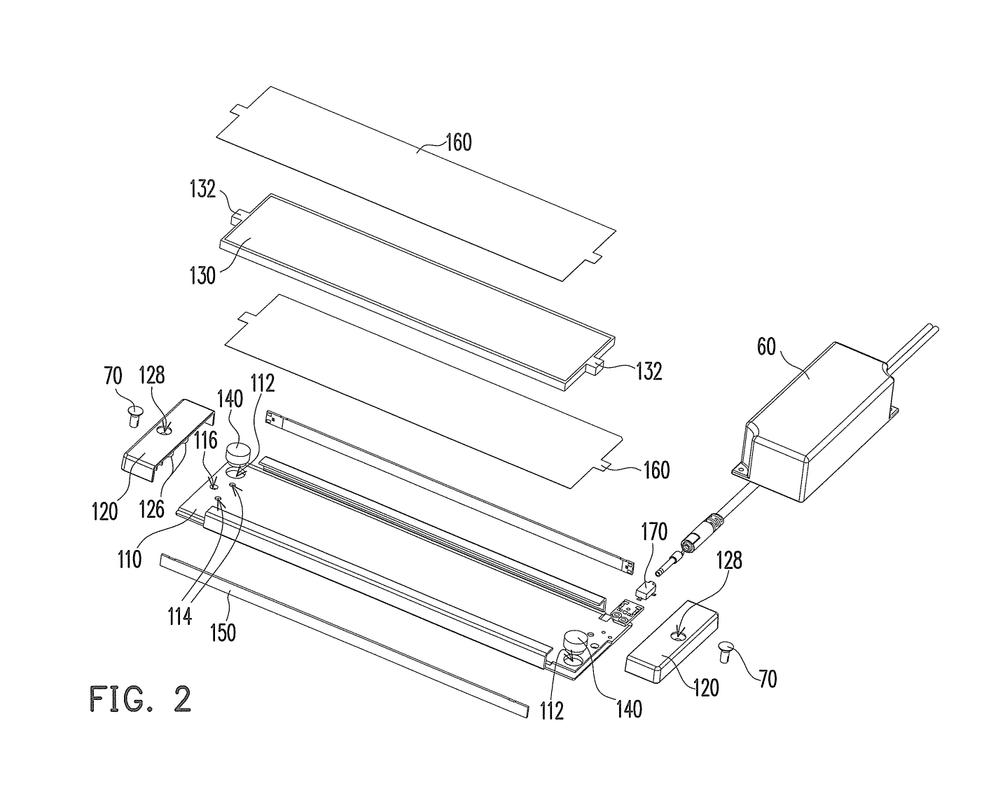

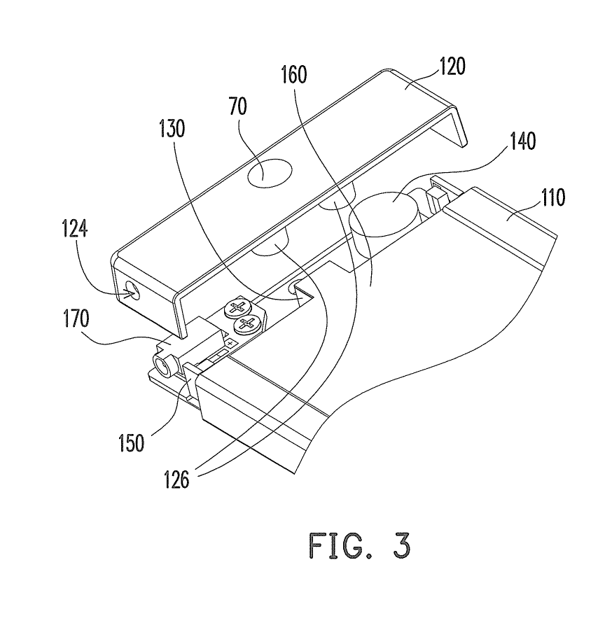

FIG. 1 is a three-dimensional (3D) diagram illustrating a light emitting diode (LED) lamp according to an embodiment of the invention. FIG. 2 shows an explosion diagram of the LED lamp in FIG. 1. FIG. 3 shows a partial explosion diagram of the LED lamp in FIG. 1. Referring to FIGS. 1 to 3, an LED lamp 100 of the embodiment includes a back plate 110, covers 120 (two are illustrated here), a light guide plate 130, magnetic elements 140 (two are illustrated here), and LED light sources 150 (two are illustrated here). The covers 120 are fixed to the back plate 110. The light guide plate 130 is disposed on the back plate 110 and a part of the light guide plate 130 is sandwiched between the back plate 110 and the cover 120. Each of the magnetic elements 140 is disposed on the back plate 110 and sandwiched between the back plate 110 and the cover 120. Each of the LED light sources 150 is disposed at a side of the light guide plate 130.

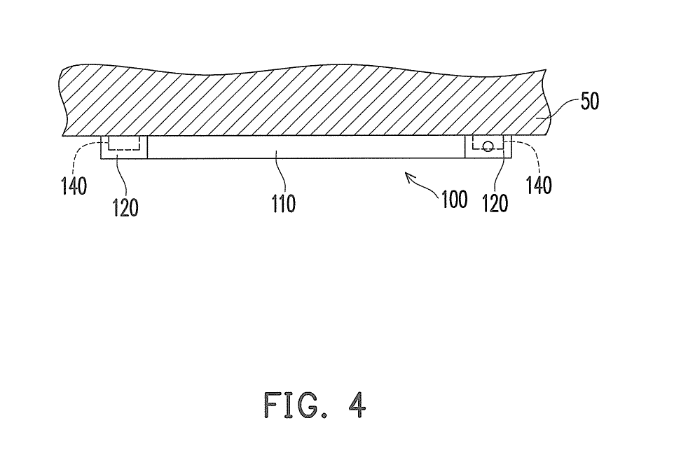

FIG. 4 illustrates a schematic diagram of fixing the LED lamp in FIG. 1 on a surface. The back plate 110 is suitable to be fixed on a surface 50 through the magnetic element 140. The surface 50 is, for example, a partition in an office, a metal surface, or other surface having magnetic attraction to the magnetic elements 140. Accordingly, the back plate 110 could be installed on the surface 50 without screwing, such that the installation and un-installation thereof become more convenient. In addition, the cover 120 configured to fix the magnetic elements 140 also functions to fix the light guide board 130, such that the entire structure is more stable and the assembly of the components could be simplified.

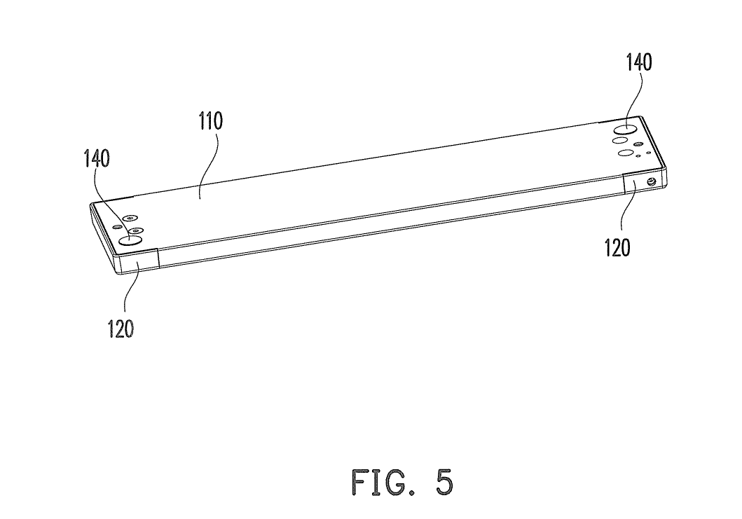

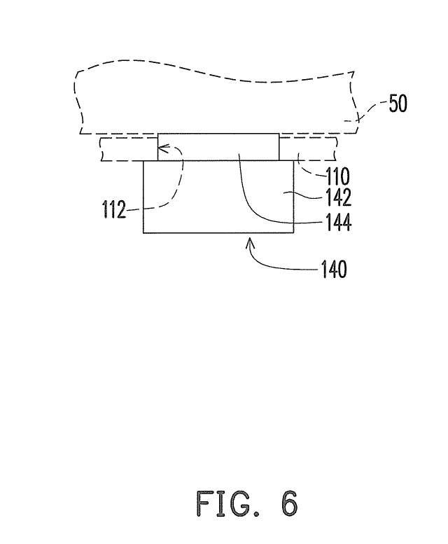

FIG. 5 is a 3D diagram of the LED lamp in FIG. 1 from another viewing angle. Referring to FIGS. 2 and 5, the back plate 110 of the embodiment has penetration holes 112 and a part of the magnetic element 140 passes through the penetration hole 112 to contact the surface 50. A part of the magnetic element 140 is exposed outside of the back plate 110 and has a stronger magnetic attraction to the surface 50. FIG. 6 depicts a side view of a magnetic element in FIG. 2. Referring to FIG. 6, in details, the magnetic elements 140 of the embodiment are, for instance, permanent magnets and each includes a body 142 and an extension part 144 that are connected to each other. The body 142 has an outer diameter larger than a diameter of the penetration hole 112. Consequently, the body 142 is suitable to be leaned on the back plate 110 and the extension part 144 passes through the penetration hole 112 so as to be exposed outside of the back plate 110 for contacting the surface 50.

As shown in FIG. 2, in the embodiment, the two covers 120 are fixed at two ends of the back plate 110 respectively, and each of the magnetic elements 140 is sandwiched between the back plate 110 and the corresponding cover 120. By disposing the two magnetic elements 140 respectively at the two ends of the back plate 110, the LED lamp 100 is stably fixed to the surface 50 through the magnetic attraction of the two magnetic elements 140. Specifically, the light guide plate 130 in the embodiment has two protrusions 132. The two protrusions 132 are extended from two ends of the light guide plate 130 respectively. Each of the protrusions 132 is sandwiched between the back plate 110 and the corresponding cover 120 to fix a position of the light guide plate 130. The LED lamp 100 in the embodiment further includes optical films 160 (two are illustrated). The optical films 160 are stacked on the light guide plate 130. The optical films 160 and the light guide plate 130 are commonly sandwiched between the back plate 110 and the covers 120.

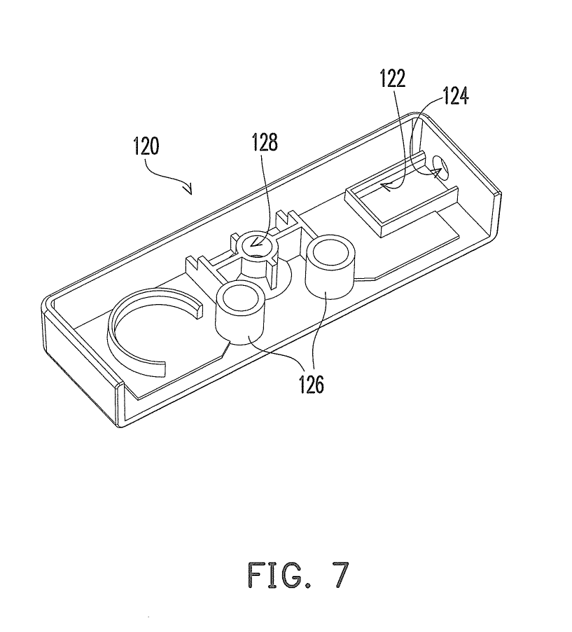

FIG. 7 is a 3D diagram showing a cover in FIG. 1. Referring to FIGS. 3 and 7, in the embodiment, the LED lamp 100 further includes a power outlet 170. The power outlet 170 is disposed between the back plate 110 and the cover 120. The cover 120 has a limit groove 122 and an opening 124 on a surface facing the back plate 110. When the cover 120 is fixed to the back plate 110 and covers the power outlet 170, the power outlet 170 is limited to locate within the limit groove 122 so as to further fix a position of the power outlet 170. The opening 124 is configured to expose the power outlet 170, so that the power outlet 170 is suitable for connecting a power device 60 shown in FIG. 2. The LED lamp 100 and the power device 60 could be isolated through the disposition of the power outlet 170 for the convenience of carrying and packaging.

Referring to FIGS. 2 and 7, each of the covers 120 in the embodiment has pillars 126 (two are illustrated) and a first fastening hole 128. The back plate 110 has fixing holes 114 (two are illustrated) and a second fastening hole 116. The two pillars 126 are suitable for inserting into the two fixing holes 114 respectively so as to fix a relative position of the cover 120 and the back plate 110. A user could pass a fastener 70 through the first fastening hole 128 and fasten the fastener 70 into the second fastening hole 116 to fix the cover 120 to the back plate 110.

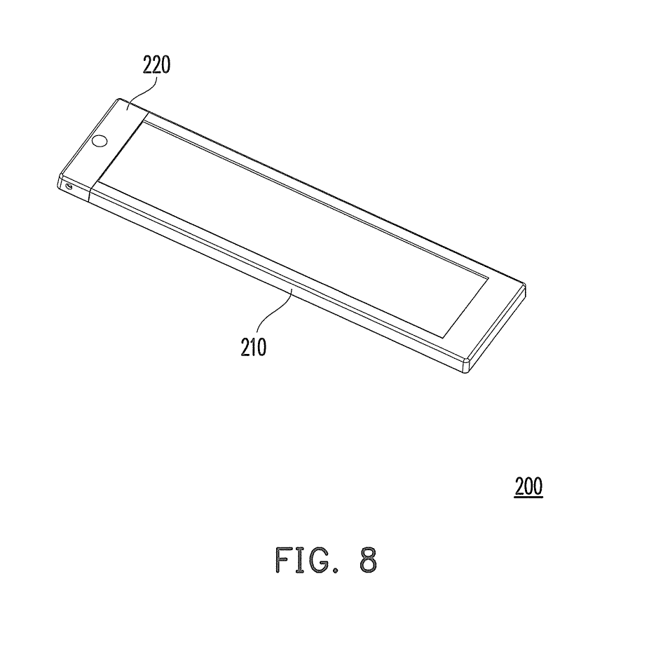

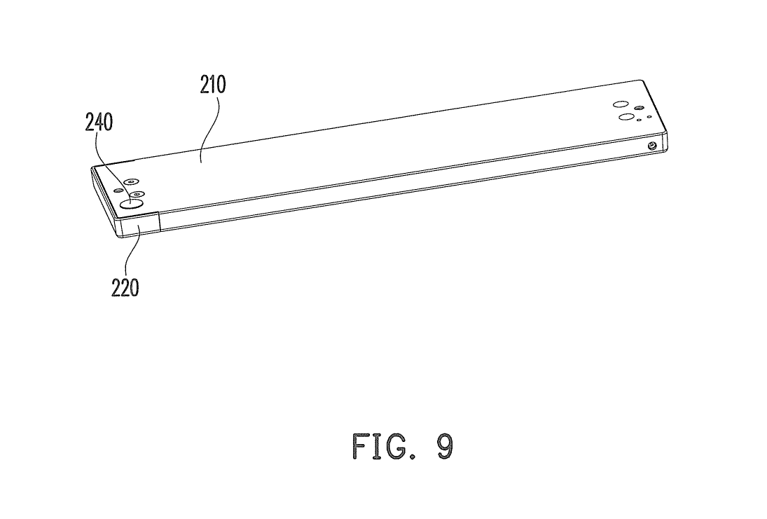

FIG. 8 is a 3D diagram illustrating an LED lamp according to another embodiment of the invention. FIG. 9 is a 3D diagram of the LED lamp in FIG. 8 from another viewing angle. Referring to FIGS. 8 and 9, an LED lamp 200 of the embodiment could only have a cover 220 and a magnetic element 240. The cover 220 fixes the magnetic element 240 to one end of a back plate 210. Another end of the back plate 210 is an integrative structure.

In summary, the embodiment or the embodiments aforementioned may have at least one following advantage. The LED lamp is fixed to the surface through the magnetic element without screwing, so that the installation and un-installation of the lamp become more convenient. In addition, the cover configured to fix the magnetic element also functions to fix the light guide board, such that the entire structure is more stable and the assembly of the components could be simplified. Furthermore, a power outlet configured to connect a power device could be disposed between the cover and the back plate, so that the LED lamp and the power device are separable to each other and thus more convenient of carrying and packaging.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light emitting diode lamp, comprising:
a back plate;
at least one cover fixed to the back plate;
a light guide plate disposed on the back plate, wherein a part of the light guide plate is sandwiched between the back plate and the at least one cover;
at least one magnetic element disposed on the back plate and sandwiched between the back plate and the at least one cover; and
a light emitting diode light source disposed at a side of the light guide plate.

2. The light emitting diode lamp as claimed in claim 1, wherein the back plate has a penetration hole and a part of the at least one magnetic element passes through the penetration hole and is exposed outside of the back plate.

3. The light emitting diode lamp as claimed in claim 2, wherein the at least one magnetic element comprises a body and an extension part connected with the body, an outer diameter of the body is larger than a diameter of the penetration hole, and the extension part passes through the penetration hole and is exposed outside of the back plate.

4. The light emitting diode lamp as claimed in claim 1, wherein the at least one magnetic element is a permanent magnet.

5. The light emitting diode lamp as claimed in claim 1, further comprising an optical film stacked on the light guide plate, wherein the optical film is stacked on the light guide plate, and the optical film and the light guide plate are commonly sandwiched between the back plate and the at least one cover.

6. The light emitting diode lamp as claimed in claim 1, wherein the numbers of the at least one cover and the at least one magnetic element are both two, the two covers are fixed to two ends of the back plate respectively and each of the two magnetic elements is sandwiched between the back plate and the corresponding cover.

7. The light emitting diode lamp as claimed in claim 1, wherein the light guide plate has two protrusions extending from two ends of the light guide plate respectively, and each of the protrusions is sandwiched between the back plate and the corresponding cover.

8. The light emitting diode lamp as claimed in claim 1, further comprising a power outlet disposed between the back plate and the at least one cover, wherein the at least one cover has a limit groove on a surface of the at least one cover facing the back plate and the power outlet is limited to locate within the limit groove.

9. The light emitting diode lamp as claimed in claim 8, wherein the at least one cover has an opening exposing the power outlet.

10. The light emitting diode lamp as claimed in claim 1, wherein the at least one cover has at least one pillar, the back plate has at least one fixing hole, and the pillar is inserted into the fixing hole to fix a relative position of the at least one cover and the back plate.

11. The light emitting diode lamp as claimed in claim 1, wherein the back plate has a first fastening hole and the at least one cover has a second fastening hole aligned to the first fastening hole.
